(19) United States
(12) Patent Application Publication
(10) Pub. No.: US 2004/0047284 A1
(43) Pub. Date: Mar. 11, 2004

(54) Transmit diversity framing structure for multipath channels

(76) Inventor: Donald Brian Eidson, San Diego, CA (US)

Correspondence Address: Semion Talpalatsky, Esq., CONEXANT SYSTEMS, INC., 4311 Jamboree Road, Newport Beach, CA, 92660-3095, US

(21) Appl. No.: 10/389,272

(22) Filed: Mar. 14, 2003

Related U.S. Application Data
(63) Continuation-in-part of application No. 10/099,556, filed on Mar. 13, 2002.

(51) Int. Cl. H04J 11/00

(52) U.S. Cl. 370/203

(57) ABSTRACT

Systems and techniques are disclosed for framing and processing single-carrier and/or OFDM transmit-diversity transmissions through delay-spread channels, as well as for deframing and processing the corresponding merged signals, received from a plurality of antennas, to estimate the transmitted information. Time-domain processing techniques may be used for both types of transmissions to create multiplexed dual signal-unit pairs, particularly when cyclic prefixes are needed to reduce delay-spreading effects. Repetitive pilot words may be employed in burst preambles and/or in payloads of transmission bursts to minimize or provide flexibility in the amount of bandwidth that is consumed to generate good channel response estimates under changing channel conditions.

This application is a continuation-in-part of U.S. patent application Ser. No. 10/099,556, “Transmit Multiplexing and Receive Processing for Delay Spread Channels,” filed Mar. 13, 2002, the entire contents of which is hereby incorporated by reference herein.

### BACKGROUND OF THE INVENTION

1. Field of the Invention

This invention generally relates to wireless communications links, and, more specifically, to frame structures for diverse antenna transmissions.

2. Related Art

Virtually all wireless communication channels are limited in their ability to accurately communicate data by the signal-to-noise ratio (SNR) of the wireless channel. Antenna diversity is one category of techniques that may be used to enhance the effective SNR of communications channels, and thus enhance the ability to accurately transmit data.

Antenna diversity can be incorporated at the transmitter, or at the receiver, or both. However, for the cost-sensitive subscriber station, diversity is much cheaper if it is instantiated at the base station transmitter (where its benefits and costs may be shared by all subscribers), rather than at every subscriber station. In installations where a great deal of diversity is required for reliable service, multiplicities of diversity may be achieved if the base station transmitter and the subscriber station receiver both possess diversity. Mechanisms to realize transmit diversity are of great utility for wireless communications.

Many transmit diversity techniques have been proposed in the literature. One such technique is transmit delay diversity. At the transmitter, delay diversity is achieved by using two antennas that transmit the same signal, with the second antenna to transmitting a delayed replica of that transmitted by the first antenna. By so doing, the second antenna creates diversity by establishing a second set of independent multipath elements that may be collected at the receiver. If the multipath generated by the first transmitter fades, the multipath generated by the second transmitter may not, in which case an acceptable SNR will be maintained at the receiver. This technique is easy to implement, because only the composite TX0+TX1 channel is estimated at the receiver. Transmit delay diversity does not require the receiver to have special a-priori knowledge that the transmitter is using this type of diversity, because the receiver's equalizer compensates automatically for the additional multipath diversity induced by the second transmit antenna.

Both OFDM and single carrier modulation can easily implement a delay diversity scheme. The biggest drawback to transmit delay diversity is that it increases the effective delay spread of the channel, and can perform poorly when the multipath introduced by the second antenna falls upon, and interacts destructively with, the multipath of the first antenna, thereby reducing the overall level of diversity.

Another transmit diversity technique of low-to-moderate complexity is described in “A simple transmit diversity scheme for wireless communications,” S. Alamouti, IEEE Journal on Select Areas in Communications, vol. 16, no. 8 Oct. 1998, pp. 1451-1458. This technique provides two-way maximal ratio-combining diversity. Unfortunately, the Alamouti transmit diversity scheme cannot be directly applied to systems experiencing delay spread, because it relies on an ability to isolate pairs of multiplexed symbols from each other, that is, the receiver must be able to process each pair of symbols without significant interaction from other pairs of symbols. In delay-spread channels, where symbol energy not only overlaps other symbols, but indeed may span hundreds of symbols, such absence of interaction cannot be relied upon. A transmit diversity technique that overcomes some of the limitations of the foregoing is described herein.

Transmit diversity techniques rely upon estimations of the symbol content of received signals. Estimating and compensating for transfer characteristics of the wireless channel, in turn, generally improves the symbol estimates. Irrespective of the basic transmit diversity technique used, techniques to enhance the symbol estimation will improve the overall ability of a communication system to accurately transfer data. Accordingly, there is a need for techniques to enhance the data transmission effectiveness of basic transmit diversity multiplexing techniques.

### SUMMARY

Processing techniques and framing structures to enhance the effectiveness of transmit-diversity wireless communications, and systems employing such techniques and structures, are disclosed herein that may be used to enhance the effectiveness of communications transmitted by diverse antennas, particularly when the transmission channels have delay-spread characteristics. Multiplexing techniques to provide a plurality of signals for a corresponding plurality of transmit antennas are disclosed, as well as corresponding receiver combining and equalization techniques. Data structures are also disclosed for use in conjunction with diversity multiplexing techniques, particularly for delay-spread channels. Framing and processing techniques are disclosed that are applicable to single-carrier and/or OFDM transmit-diversity transmissions and receptions through delay-spread channels.

One embodiment is a method of transmitting dual signal-unit pairs from diverse antennas. It includes processing a plurality of N-point signal units each into a plurality of forms using time-domain techniques, and prepending a cyclic prefix on each of the resulting forms, before transmitting the prefixed forms of the signal units in concurrent pairs from the diverse antennas.

Another embodiment is a method of interpreting received signals that were transmitted in multiplexed forms from diverse transmit antennas. The method includes identifying received pilot words that include cyclically prefixed first and second pilot signal units. The method further includes ignoring the cyclic prefixes and combining forms of the first and second pilot signal units with first and second expected pilot symbol units to derive first and second channel estimates. The method further includes deriving estimates of transmitted payload signal units by combining forms of the channel estimates with forms of received payload signal units.

A further embodiment is a method of transmitting dual signal-unit pairs from diverse antennas. The method includes deriving a plurality of pilot signal units from portions of pilot data expected by a receiver, establishing a variant form of each signal unit, and cyclically prefixing the signal units and their variants. The method also includes transmitting, substantially concurrently, appropriate pairs of these various cyclically prefixed signal units. The method yet further includes transmitting a repetitive pilot signal unit by transmitting an appropriate signal unit pair one or more additional times, without cyclic prefixes, immediately after they have been transmitted with a cyclic prefixes.

Yet another embodiment is a system that may be used for transmitting dual signal-unit pairs from diverse antennas. The system includes first and second antennas and a signal-unit derivation block configured to derive N-point signal-units of time-domain samples from modulated source information. It also includes a diversity multiplexer block configured to multiplex pairs of the derived N-point signal units into multiplexed dual signal-unit pairs, each having first and second N-point multiplexed-signal-units (“MSUs”) for the first antenna, and first and second N-point MSUs for the second antenna, where the first N-point MSU for the first antenna is related to the second N-point MSU for the second antenna by complex conjugation and modulo-N sample time inversion, and the second N-point MSU for the first antenna is related to the first N-point MSU for the second antenna by complex conjugation, negation, and modulo-N sample time inversion. The system also includes a first output processing block configured to cyclically prefix the first and second N-point MSUs for the first antenna, and to process the prefixed MSUs for sequential transmission from the first antenna; and a second output processing block configured to cyclically prefix the first and second N-point MSUs for the second antenna, and to process the prefixed MSUs for sequential transmission from the second antenna substantially concurrently with the sequential transmission from the first antenna.

Yet a further embodiment is a receiver system that may be used for receiving paired multiplexed signals transmitted from plural antennas. The system of this embodiment includes a receive and alignment block configured to receive and align prefixed multiplexed-signal-units (“MSUs”) received sequentially in a frame structure having a preamble portion and a payload portion, and a cyclic prefix removal block configured to remove cyclic prefixes from received MSUs. The system also includes a pilot word identification block configured to identify, in accordance with relative position within the frame structure, J concatenated copies of a first received pilot MSU, RP₀, followed by P concatenated copies of a second received pilot MSU, RP₁, that were transmitted based upon a first expected pilot signal-unit EP₀ and a second expected pilot signal-unit EP₁, and a channel estimation block configured to combine a representation of RP₀ and a representation of RP₁ with complex conjugated forms of EP₀ and EP₁ to create a first channel estimate HE₁, and to combine the representations of RP₀ and RP₁ with forms of EP₀ and EP₁ that are not complex conjugated to create a second channel estimate HE₂.

### BRIEF DESCRIPTION OF THE DRAWINGS

Embodiments of the present invention will be more readily understood by reference to the following figures, in which like reference numbers and designations indicate like elements.

FIG. 1 illustrates temporal organization of a block pair.

FIG. 2 illustrates concatenation of block pairs for transmission.

FIG. 3 is a matrix showing a dual block pair signal multiplexing relationships.

FIG. 4 is a signal flow diagram of a Decision Feedback Equalizer.

FIG. 5 shows a Unique Word variation of the multiplexing of FIG. 3.

FIG. 6 illustrates a burst transmission using a Unique Word preamble.

FIG. 7 shows Pilot Words disposed in a general payload transmission.

FIG. 8 illustrates a use of cyclic prefixes with the multiplexing of FIG. 3.

FIG. 9 illustrates using Unique Words for cyclic prefixes in block pairs.

FIG. 10 shows a dual block pair multiplexing transmission format.

FIG. 11 illustrates communication system features including plural receivers.

FIG. 12 is a block diagram of transmit diversity processing for single-carrier applications using time domain multiplexing.

FIG. 13 illustrates dual block pair signal multiplexing relationships for OFDM.

FIG. 14 is a block diagram of transmit diversity processing for OFDM applications using frequency domain multiplexing.

FIG. 15 shows a modification of the processing of FIG. 14 to use time domain multiplexing and avoid some FFTs.

FIG. 16 is a block diagram showing OFDM transmit diversity receive processing.

FIG. 17 illustrates an example of preamble framing for OFDM transmit diversity.

### DETAILED DESCRIPTION

Multiplexed data may be transmitted over two or more antennas, as described more fully below, to enhance the reliability of communication with a receiver (or receivers). The techniques described are particularly effective when the communication is conducted over multipath delay spread channels. Two-antenna diversity can double the effective diversity level of a system operating over such channels. Of course, multipath, in itself, is a form of diversity. Thus, for example, with a system operating over a single channel with three multipaths and having (therefore) a diversity level of three; use of two transmit antennas (with one receiver) as described below could increase the diversity level to 6 (or more). Embodiments that further employ two or more receivers may increase the diversity gains even further.

### Single Carrier Transmnit Diversity

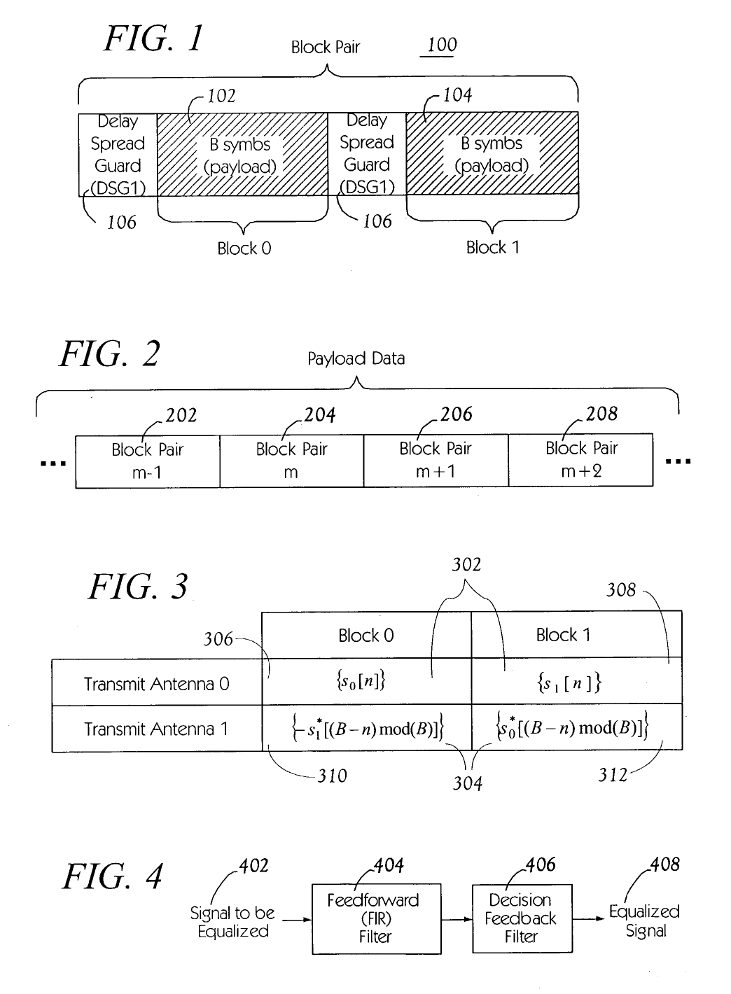

This description assumes a communication system that is configured to transfer selected signals from a transmission system having a plurality of transmit antennas to a receiving system having one or more antennas. The desired transmission signals are assumed to at least partly take the form of symbols defined in the time domain. FIG. 1 illustrates that a selected number B of symbols may be organized as a symbol block, such as a “Block 0” 102 or a “Block 1” 104. Ideally, a delay spread guard period 106 is provided before each block (e.g., 102 and 104). For convenience, delay spread guard periods will typically have the same length, D, which may be measured in symbol lengths or time. The length, D, of these delay spread guard regions would typically be longer than the delay spread span of the channel. In one embodiment, these delay spread guard regions would have a ‘cyclic prefix’ format; i.e., they would be composed of the last D symbols of the block that follows them. A combination of sequential blocks, such as the illustrated Block 0 and Block 1, each preceded by a delay spread guard having a known length that may range down to zero, fonrs a block pair 100. Note that the two blocks within a block pair are logically paired together, but physically separated from themselves (or other data) by delay spread guard regions 106. In general, any particular block, such as the “Block 0” 102, may be the same or different from the other block (e.g., “Block 1” 104) of its block pair 100. It will generally be useful, for minimizing bit error rate (BER) characteristics, if the channels from each antenna to the receiving. system do not change significantly between the beginning and end of transmission of a block pair. Note that the symbols within a block should be adjacent, but that blocks composing a block pair do not have to be adjacent, although they are pictured that way in FIGS. 1 and 2.

FIG. 2 illustrates a sequence of block pairs, including block pairs (m−1) 202, (m) 204, (m+1) 206 and (m+2) 208, which have been concatenated for transmission as an extended payload from a particular antenna. In general, any block pair transmitted from a particular antenna may be different from or identical to any other block pair transmitted from the same antenna at another time.

Block Pair Transmit Multiplexing

FIG. 3 indicates a block multiplexing structure that a two-antenna transmitter may use to transmit the information of each of two sequences in two related forms over block pairs 302 and 304 that resemble the block pair 100 (see FIG. 1). {s₀[n]} is a signal set describing a first block 306 of the block pair 302 transmitted by Transmit Antenna 0, while {s₁[n]} is a signal set that describes a second block 308 of the block pair 302. {s₀[n]} and {s₁[n]} each describe a sequence of length B symbols, 0≦n<B−1, that represents information that is to be delivered to a receiver via the two transmit antennas.

A block 310 is the first block of the block pair 304 transmitted by Transmit Antenna 1, while block 312 is the second block of the block pair 304 transmitted by Transmit Antenna 1. The first block 306 of the block pair 302 conveys the same information as the second block 312 of the block pair 304, but in a different form. As compared to the block 306, the block 312 is a time-inverted sequence of the complex conjugate of the symbols that form the symbol sequence {s₀[n]}. Similarly, the first block 310 of the block pair 304 is a time-inverted sequence of the negative complex conjugate of the symbols of the sequence {s₁[n]}.

Thus, Transmit Antenna 1 transmits blocks having the same information as is transmitted by related blocks of Transmit Antenna 0, but in reverse time order, and the blocks of Transmit Antenna 1 have a sequence of symbols that are the (positive or negative) complex conjugate of the symbols of the related blocks of Transmit Antenna 0 in a sequence that is also time-reversed cyclically about zero, modulo-B.

It should be understood that the signal sets {s₀[n]} and {s₁[n]} are only nominally in an “unmodified” form. Either or both {s₀[n]} and {s₁[n]} may, of course, be related to other symbol sequences that are the actual symbols which are being sent. Thus, either of these signals may in fact be, for example, a time-inverted, negated and/or complex-conjugated version of the actual desired symbols. This merely reflects the generality of the signal sets {s₀[n]} and {s₁[n]}, and does not affect the relationship between blocks that are diagonally positioned within the space-time matrix of blocks shown in FIG. 3.

Transmit and Receive Signal Relationships

Define S₀(e^{jω}), S₁(e^{jω}), N₀(e^{jω}), N₁(e^{jω}), H₀(e^{jω}), and H₁(e^{jω}) as the Discrete-time Fourier transforms (DTFTs), respectively, of the symbol sequences {s₀[n]} and {s₁[n]} (each normalized, without loss of generality, so that their average symbol energy is 1); additive white, zero-mean, σ²-variance noise sequences {n₀[n]} and {n₀[n]}; and the channel impulse responses {h₀[n]} and {h₁[n]} that are associated with each transmit antenna Due to the multiplexed transmit signals, each received block of payload symbols (which is typically separated from other blocks by delay spread guard intervals) includes information from both blocks of a received block pair. Accordingly, the information from individual blocks can only be extracted by combining information from the two blocks of a block pair. The received signals associated with each individual block of a block pair, interpreted in the frequency domain, are:

$$\begin{matrix}{R}_{0} ( {ⅇ}^{j ω} ) = {H}_{0} ( {ⅇ}^{j ω} ) {S}_{0} ( {ⅇ}^{j ω} ) - {H}_{1} ( {ⅇ}^{j ω} ) {S}_{1}^{*} ( {ⅇ}^{j ω} ) + {N}_{0} ( {ⅇ}^{j ω} ) \\ {R}_{1} ( {ⅇ}^{j ω} ) = {H}_{0} ( {ⅇ}^{j ω} ) {S}_{1} ( {ⅇ}^{j ω} ) + {H}_{1} ( {ⅇ}^{j ω} ) {S}_{0}^{*} ( {ⅇ}^{j ω} ) + {N}_{1} ( {ⅇ}^{j ω} )\end{matrix} . \qquad Eqn . 1$$

Note that DTFTs are used for frequency domain descriptions for generality, but this is in no way limiting: a B-point (or, more generally, an implementation using a K-point) Discrete Fourier Transform (DFT) would uniformly sample the DTFT response over the interval ωε[0,2π), yielding B (or K) samples.

The received signal is a merger of the concurrently transmitted blocks, so processing facilities should identify received block pairs (through their time relationship with a preamble, for example), and combine forms of the received block pairs with forms of the channel response estimates. Assuming that the frequency domain channel responses H₀(e^{jω}) and H₁(e^{jω}) are known (or estimated), a received block pair R₀ and R₁ may be filtered and combined according to the frequency domain combining scheme

$$\begin{matrix}{C}_{0} ( {ⅇ}^{j ω} ) = {H}_{0}^{*} ( {ⅇ}^{j ω} ) {R}_{0} ( {ⅇ}^{j ω} ) + {H}_{1} ( {ⅇ}^{j ω} ) {R}_{1}^{*} ( {ⅇ}^{j ω} ) \\ {C}_{1} ( {ⅇ}^{j ω} ) = - {H}_{1} ( {ⅇ}^{j ω} ) {R}_{0}^{*} ( {ⅇ}^{j ω} ) + {H}_{0}^{*} ( {ⅇ}^{j ω} ) {R}_{1} ( {ⅇ}^{j ω} )\end{matrix} . \qquad Eqn . 2$$

Processing the block pair, R₀ and R₁, thus includes filtering various forms of the received blocks with a form of a channel estimate, and in the frequency domain the filtering may consist of multiplying a form of a channel estimate by a form of a received block. The appropriate filtered results are then combined (in the frequency domain case, added) to produce a pair of combiner outputs C₀ and C₁. Using the expanded representation of the received blocks provided by Eqn. 1, the combiner outputs are seen to be

$$\begin{matrix}\begin{matrix}{C}_{0} ( {ⅇ}^{j ω} ) = ( {\vert {H}_{0} ( {ⅇ}^{j ω} ) \vert}^{2} + {\vert {H}_{1} ( {ⅇ}^{j ω} ) \vert}^{2} ) {S}_{0} ( {ⅇ}^{j ω} ) + \\ {H}_{0}^{*} ( {ⅇ}^{j ω} ) {N}_{0} ( {ⅇ}^{j ω} ) + {H}_{1} ( {ⅇ}^{j ω} ) {N}_{1}^{*} ( {ⅇ}^{j ω} )\end{matrix} \\ \begin{matrix}{C}_{1} ( {ⅇ}^{j ω} ) = ( {\vert {H}_{0} ( {ⅇ}^{j ω} ) \vert}^{2} + {\vert {H}_{1} ( {ⅇ}^{j ω} ) \vert}^{2} ) {S}_{1} ( {ⅇ}^{j ω} ) - \\ {H}_{1} ( {ⅇ}^{j ω} ) {N}_{0}^{*} ( {ⅇ}^{j ω} ) + {H}_{0}^{*} ( {ⅇ}^{j ω} ) {N}_{1} ( {ⅇ}^{j ω} )\end{matrix}\end{matrix} . \qquad Eqn . 3$$

Applying the following definitions:

$$\begin{matrix}D ( {ⅇ}^{j ω} ) ≡ ( {\vert {H}_{0} ( {ⅇ}^{j ω} ) \vert}^{2} + {\vert {H}_{1} ( {ⅇ}^{j ω} ) \vert}^{2} ) & Eqn . 4 \\ and & \\ \begin{matrix}{N}_{{C}_{0}} ( {ⅇ}^{j ω} ) = {H}_{0}^{*} ( {ⅇ}^{j ω} ) {N}_{0} ( {ⅇ}^{j ω} ) + {H}_{1} ( {ⅇ}^{j ω} ) {N}_{1}^{*} ( {ⅇ}^{j ω} ) \\ {N}_{{C}_{1}} ( {ⅇ}^{j ω} ) = - {H}_{1} ( {ⅇ}^{j ω} ) {N}_{0}^{*} ( {ⅇ}^{j ω} ) + {H}_{0}^{*} ( {ⅇ}^{j ω} ) {N}_{1} ( {ⅇ}^{j ω} )\end{matrix} , & Eqn . 5\end{matrix}$$

the expressions for the fiequency domain representation of the combiner outputs C₀(e^{jω}) and C₁(e^{jω}) become

$$\begin{matrix}{C}_{0} ( {ⅇ}^{j ω} ) = D ( {ⅇ}^{j ω} ) {S}_{0} ( {ⅇ}^{j ω} ) + {N}_{{C}_{0}} ( {ⅇ}^{j ω} ) \\ {C}_{1} ( {ⅇ}^{j ω} ) = D ( {ⅇ}^{j ω} ) {S}_{1} ( {ⅇ}^{j ω} ) + {N}_{{C}_{1}} ( {ⅇ}^{j ω} )\end{matrix} \qquad Eqn . 6$$

In view of Eqn. 6, estimates of S₀(e^{jω}) and S₁(e^{jω}) may be obtained using any equalization technique that will substantially remove the influence of D(e^{jω}).

Equalization

Many equalization techniques exist. A linear equalizer may be used in an effort to eliminate D(e^{jω}) through pre-multiplication by an appropriate equalizer characteristic that is generally inverse to D(e^{jω}):

$$\begin{matrix}{{\hat{S}}_{0} ( {ⅇ}^{j ω} )}_{linear} = {E ( {ⅇ}^{j ω} )}_{linear} {C}_{0} ( {ⅇ}^{j ω} ) \\ {{\hat{S}}_{1} ( {ⅇ}^{j ω} )}_{linear} = {E ( {ⅇ}^{j ω} )}_{linear} {C}_{1} ( {ⅇ}^{j ω} )\end{matrix} . \qquad Eqn . 7$$

Linear equalizer functions may take various forms. As examples, the linear equalizer solution obtained using a zero forcing (ZF) optimization criterion would be

$${E ( {ⅇ}^{j ω} )}_{linear}^{ZF} = \frac{1}{D ( {ⅇ}^{j ω} )} , \qquad Eqn . 8$$

whereas a linear equalizer solution obtained using a Minimum Mean Squared Error (MMSE) optimization criterion would be

$${E ( {ⅇ}^{j ω} )}_{linear}^{MMSE} = \frac{1}{D ( {ⅇ}^{j ω} ) + {σ}^{2}} . \qquad Eqn . 9$$

Because D is defined in Eqn. 4, frequency domain processing facilities may therefore equalize the combiner outputs by dividing each output by a quantity that reflects a sum of the individual channel response magnitudes. In the case of MMSE, the divisor sum further includes a term σ² that reflects a normalized reciprocal of the signal to noise ratio (SNR) measured for the received signal. The aforesaid equalization results may be directly interpreted as estimates Ŝ₀(e^{jω}) and Ŝ₁(e^{jω}), whereupon (soft) equalized estimates of the symbol sequences {s₀[n]} and {s₁[n]} may be obtained directly by computing inverse DTFTs (I-DTFTs) of the estimates.

Instead of performing frequency domain processing, the facilities may perform combining and equalization in the time domain using block length-B circular convolutions (denoted by the operator ‘\mathring{x}’), where

$$\begin{matrix}\begin{matrix}{{\hat{s}}_{0} [ n ]}_{linear} = {e}_{linear} [ n ] ⊗ {c}_{0} [ n ] \\ {{\hat{s}}_{1} [ n ]}_{linear} = {e}_{linear} [ n ] ⊗ {c}_{1} [ n ]\end{matrix} , & Eqn . 10 \\ \begin{matrix}\begin{matrix}{c}_{0} [ n ] = {h}_{0}^{*} [ ( B - n ) mod ( B ) ] ⊗ {r}_{0} [ n ] + \\ {h}_{1} [ n ] ⊗ {r}_{1}^{*} [ ( B - n ) mod ( B ) ]\end{matrix} \\ \begin{matrix}{c}_{1} [ n ] = - {h}_{1} [ n ] ⊗ {r}_{0}^{*} [ ( B - n ) mod ( B ) ] + \\ {h}_{0}^{*} [ ( B - n ) mod ( B ) ] ⊗ {r}_{1} [ n ]\end{matrix}\end{matrix} , & Eqn . 11\end{matrix}$$

and the lower-case variables are time domain representations of upper-case frequency domain variables. Thus, in the tine domain the combiner outputs may be based on forms of received blocks filtered by forms of channel estimates, just as in the frequency domain. In the time domain case, the various forms of the received blocks, and of the channel estimates, may differ by not only complex conjugation (positive or negative), but also by time-reordering of the symbol sequences, and in particular by cyclic time reversal of the time sequence of the corresponding block symbols. The equalization filtering may be performed by circular convolution between block-length sequences. The equalizer e^{linear}[n] may be derived from an I-DTFT of E(e^{jω})ₗᵢₙₑₐᵣ if frequency domain information on the channel impulse responses is immediately available. If not, the time domain responses may be frequency transformed to generate H₀(e^{jω}) and H₁(e^{jω}), and then E(e^{jω})ₗᵢₙₑₐᵣ May be derived, for example, by further processing according to Eqn. 8 or Eqn. 9.

FIG. 4 Illustrates equalizer elements In an equalizer subsystem that may be less prone, than a linear equalizer, to emphasize noise in frequency bands where notches occur. FIG. 4 shows a signal to be equalized 402 progressing through a typical Decision Feedback Equalizer (DFE) having two equalizer processing elements: a feedforward (linear) filter 404, and a decision feedback filter 406 that subtracts symbol decisions made in the time domain. The linear feedforward filter element 404 generates intermediate equalized results

$$\begin{matrix}{Z}_{0} ( {ⅇ}^{j ω} ) = {E ( {ⅇ}^{j ω} )}_{FF} {C}_{0} ( {ⅇ}^{j ω} ) \\ {Z}_{1} ( {ⅇ}^{j ω} ) = {E ( {ⅇ}^{j ω} )}_{FF} {C}_{1} ( {ⅇ}^{j ω} )\end{matrix} , \qquad Eqn . 12$$

and an I-DTFT may be applied to the equalized results to yield time domain sequences z₀[n] and z₁[n]. Each of these sequences may then be separately operated upon in the time domain by the decision feedback filter 406, and may use identical feedback coefficients f[n] to provide an equalized signal 408 in the form of estimates {ŝ₀[n]} and {ŝ₁[n]}.

A MMSE criterion-optimizing DFE may use the feedforward filter

$${E ( {ⅇ}^{j ω} )}_{FF}^{MMSE} = \frac{F ( {ⅇ}^{j ω} )}{D ( {ⅇ}^{j ω} ) + {σ}^{2}} , \qquad Eqn . 13$$

where F(e^{jω}) is the DTFT of f[n]. A zero-forcing solution would be identical to the MMSE solution, except that it would not possess the σ² found in Eqn. 13, which reflects the normalized reciprocal of the receiver SNR.

The frequency domain filtering described in Eqn. 12 may, in the alternative, be implemented in the time domain. The signal processing may filter the combiner outputs by circularly convolving them with an equalization sequence e_{FF}[n]:

$$\begin{matrix}{{z}_{0} [ n ]}_{linear} = {e}_{FF} [ n ] ⊗ {c}_{0} [ n ] \\ {{z}_{1} [ n ]}_{linear} = {e}_{FF} [ n ] ⊗ {c}_{1} [ n ]\end{matrix} , \qquad Eqn . 14$$

where e_{FF}[n] is the I-DTFT of E(e^{jω})_{FF}(in either its MMSE or zero-forcing forms).

### Channel Estimation

It is, of course, very helpful to obtain good channel estimates, since the estimates of the transmitted sequences may depend upon the channel estimates at a number of stages. Manipulation of Eqn. 1 reveals that the frequency domain channel characteristics can be expressed as

$$\begin{matrix}\begin{matrix}{H}_{0} ( {ⅇ}^{j ω} ) = \frac{{S}_{0}^{*} ( {ⅇ}^{j ω} ) {R}_{0} ( {ⅇ}^{j ω} ) + {S}_{1} ( {ⅇ}^{j ω} ) {R}_{1}^{*} ( {ⅇ}^{j ω} )}{{\vert {S}_{0} ( {ⅇ}^{j ω} ) \vert}^{2} + {\vert {S}_{1} ( {ⅇ}^{j ω} ) \vert}^{2}} - \\ \frac{{S}_{0}^{*} ( {ⅇ}^{j ω} ) {N}_{0} ( {ⅇ}^{j ω} ) + {S}_{1} ( {ⅇ}^{j ω} ) {N}_{1}^{*} ( {ⅇ}^{j ω} )}{{\vert {S}_{0} ( {ⅇ}^{j ω} ) \vert}^{2} + {\vert {S}_{1} ( {ⅇ}^{j ω} ) \vert}^{2}}\end{matrix} \\ \begin{matrix}{H}_{1} ( {ⅇ}^{j ω} ) = \frac{{S}_{0} ( {ⅇ}^{j ω} ) {R}_{1} ( {ⅇ}^{j ω} ) - {S}_{1} ( {ⅇ}^{j ω} ) {R}_{0} ( {ⅇ}^{j ω} )}{{\vert {S}_{0} ( {ⅇ}^{j ω} ) \vert}^{2} + {\vert {S}_{1} ( {ⅇ}^{j ω} ) \vert}^{2}} - \\ \frac{{S}_{0} ( {ⅇ}^{j ω} ) {N}_{1} ( {ⅇ}^{j ω} ) - {S}_{1} ( {ⅇ}^{j ω} ) {N}_{0} ( {ⅇ}^{j ω} )}{{\vert {S}_{0} ( {ⅇ}^{j ω} ) \vert}^{2} + {\vert {S}_{1} ( {ⅇ}^{j ω} ) \vert}^{2}} .\end{matrix}\end{matrix} \qquad Eqn . 15$$

This leads to calculations that may be performed by the receiver signal processing facilities to obtain channel estimates, including the frequency domain MMSE estimates

$$\begin{matrix}{{\hat{H}}_{0} ( {ⅇ}^{j ω} )}_{MMSE} = \frac{{S}_{0}^{*} ( {ⅇ}^{j ω} ) {R}_{0} ( {ⅇ}^{j ω} ) + {S}_{1}^{*} ( {ⅇ}^{j ω} ) {R}_{1} ( {ⅇ}^{j ω} )}{{\vert {S}_{0} ( {ⅇ}^{j ω} ) \vert}^{2} + {\vert {S}_{1} ( {ⅇ}^{j ω} ) \vert}^{2} + {σ}^{2}} \\ {{\hat{H}}_{1} ( {ⅇ}^{j ω} )}_{MMSE} = \frac{{S}_{0} ( {ⅇ}^{j ω} ) {R}_{1} ( {ⅇ}^{j ω} ) - {S}_{1} ( {ⅇ}^{j ω} ) {R}_{0} ( {ⅇ}^{j ω} )}{{\vert {S}_{0} ( {ⅇ}^{j ω} ) \vert}^{2} + {\vert {S}_{1} ( {ⅇ}^{j ω} ) \vert}^{2} + {σ}^{2}}\end{matrix} \qquad Eqn . 16$$

and zero-forcing estimates

$$\begin{matrix}{{\hat{H}}_{0} ( {ⅇ}^{j ω} )}_{ZF} = \frac{{S}_{0}^{*} ( {ⅇ}^{j ω} ) {R}_{0} ( {ⅇ}^{j ω} ) + {S}_{1}^{*} ( {ⅇ}^{j ω} ) {R}_{1} ( {ⅇ}^{j ω} )}{{\vert {S}_{0} ( {ⅇ}^{j ω} ) \vert}^{2} + {\vert {S}_{1} ( {ⅇ}^{j ω} ) \vert}^{2}} \\ {{\hat{H}}_{1} ( {ⅇ}^{j ω} )}_{ZF} = \frac{{S}_{0} ( {ⅇ}^{j ω} ) {R}_{1} ( {ⅇ}^{j ω} ) - {S}_{1} ( {ⅇ}^{j ω} ) {R}_{0} ( {ⅇ}^{j ω} )}{{\vert {S}_{0} ( {ⅇ}^{j ω} ) \vert}^{2} + {\vert {S}_{1} ( {ⅇ}^{j ω} ) \vert}^{2}}\end{matrix} . \qquad Eqn . 17$$

The channel estimates of Eqns. 16 and 17 are based upon arbitrary symbol data sequences {s₀[n]} and {s₁[n]}. Unfortunately, the arbitrary symbol data sequences must generally be estimated themselves, thus compounding any inaccuracies. It may be useful to avoid relying exclusively on such estimates for further deriving estimates of the channel response.

Preambles and Pilot Words

The channel estimation process will be less reliant on received symbol estimates when known sequences of symbols are transmitted at identifiable times. These known sequences may be referred to generally as “pilot symbols,” although it should be understood that such sequences might also appear in preambles, or in other forms. In many cases, an identical sequence will be consistently transmitted as pilot symbols, and this fact may be exploited to reduce the complexity of channel estimates computation according to algorithms Such as those listed in Eqns. 16 and 17.

Pilot sequences with constant magnitude spectrum, i.e.,

$${\vert {S}_{pilot} ( {ⅇ}^{j ω} ) \vert}^{2} = K ,$$

are desirable, because this condition reduces noise emphasis (within certain frequency bands) in the estimation process. Examples of sequences having constant magnitude spectrum properties (or, equivalently, ‘perfect’ circular autocorrelation properties) may be found, for example, within a trio of references including: “Phase Shift Codes with Good Periodic Correlation Properties” by R. L Frank and S. A. Zadoff, IRE Trans. Information Theory, October, 1962, pp. 381-382; “Polyphase Codes with Good Periodic Correlation Properties” by D. C. Chu, IEEE Trans. Information Theory, July, 1972, pp. 531-532; and “Periodic Sequences With Optimal Properties for Channel Estimation and Fast Start-up Equalization” by A. Milewski, IBM J. Res. And Development, September 1983, pp. 426-431. Each of these references is hereby incorporated herein in its entirety.

For embodiments that use such constant magnitude pilot sequences, the MMSE channel estimation step in Eqn. 16 may be reduced to

$$\begin{matrix}{{\hat{H}}_{0} ( {ⅇ}^{j ω} )}_{MMSE} = \frac{1}{2 K + {σ}^{2}} {S}_{pilot}^{*} ( {ⅇ}^{j ω} ) ( {R}_{0} ( {ⅇ}^{j ω} ) + {R}_{1} ( {ⅇ}^{j ω} ) ) \\ {{\hat{H}}_{1} ( {ⅇ}^{j ω} )}_{MMSE} = \frac{1}{2 K + {σ}^{2}} {S}_{pilot} ( {ⅇ}^{j ω} ) ( {R}_{1} ( {ⅇ}^{j ω} ) - {R}_{0} ( {ⅇ}^{j ω} ) )\end{matrix} , \qquad Eqn . 18$$

which does not rely on estimates of the transmitted signals, but instead relies upon the known pilot sequence, the frequency domain representations of the received blocks of the block pair, and a (normalized reciprocal) SNR measured for the receiver.

Note that these channel estimations may, instead, be performed in the time domain, using circular convolution of time domain versions of the received blocks, and two versions of the pilot signal (one the complex conjugate and cyclic time reversal of the other), which are known. Thus, if the pilot sequences are identical and have constant magnitude frequency response, then the receiver signal processing may perform the following functions to produce time domain channel estimates, which may then be used to combine the block pairs in the time domain, as described for example by Eqn. 11:

$$\begin{matrix}{{\hat{h}}_{0} [ n ]}_{MMSE} = \frac{1}{2 K + {σ}^{2}} {s}_{pilot}^{*} [ ( B - n ) mod ( B ) ] ⊗ ( {r}_{0} [ n ] + {r}_{1} [ n ] ) \\ {{\hat{h}}_{1} [ n ]}_{MMSE} = \frac{1}{2 K + {σ}^{2}} {s}_{pilot} [ n ] ⊗ ( {r}_{1} [ n ] - {r}_{0} [ n ] ) \end{matrix} . \qquad Eqn . 19$$

If arbitrary (but known) reference sequences are used that do not necessarily have constant magnitude response, then the receiver signal processing may derive channel estimates (in the time domain) by performing the steps of Eqn. 20:

$$\begin{matrix}\begin{matrix}{{\hat{h}}_{0} [ n ]}_{MMSE} = g [ n ] ⊗ ( {s}_{{pilot}_{0}}^{*} [ ( B - n ) mod ( B ) ] ⊗ {r}_{0} [ n ] + {s}_{{pilot}_{1}}^{*} [ ( B - n ) mod ( B ) ] ⊗ r 1 [ n ] ) \\ {{\hat{h}}_{1} [ n ]}_{MMSE} = g [ n ] ⊗ ( {s}_{{pilot}_{0}} [ n ] ⊗ {r}_{1} [ n ] - {s}_{{pilot}_{1}} [ n ] ⊗ {r}_{1} [ n ] ) \end{matrix} \\ where g [ n ] is the I \text{-} DTFT of & Eqn . 20 \\ G ( {ⅇ}^{j ω} ) = \frac{1}{{\vert {S}_{0} ( {ⅇ}^{j ω} ) \vert}^{2} + {\vert {S}_{1} ( {ⅇ}^{j ω} ) \vert}^{2} + {σ}^{2}} . & Eqn . 21\end{matrix}$$

Efficient use of pilot symbols is always a system design goal, since pilot symbols improve receiver performance but also add to system overhead. Certain pilot symbol structures, such as constant magnitude pilot sequence, are preferred because they permit efficiencies such as described above.

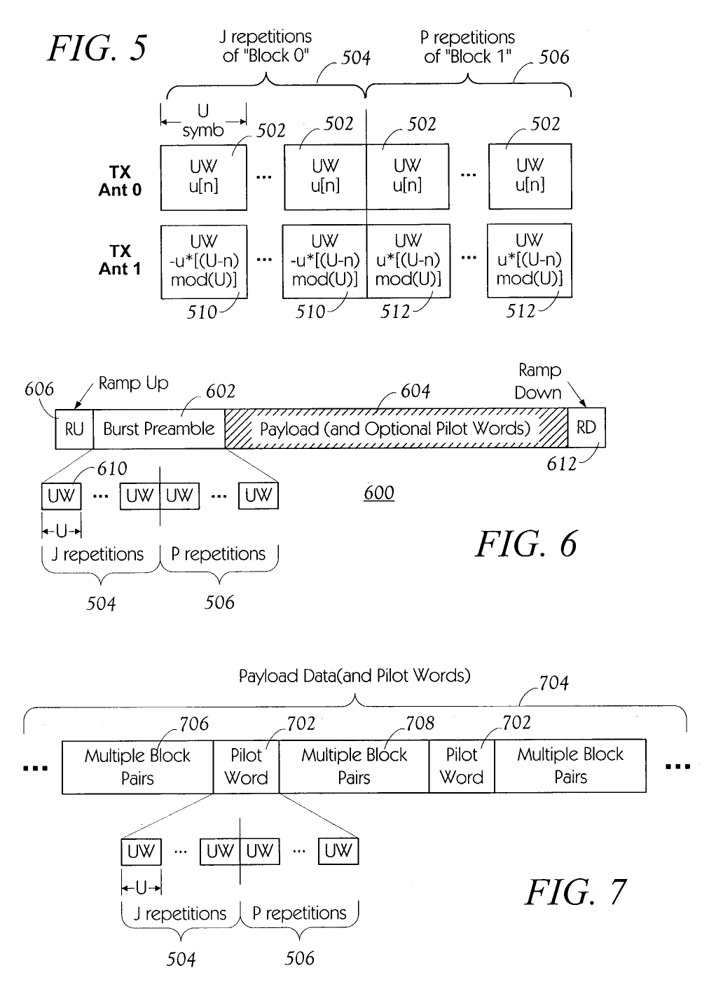

FIG. 5 illustrates a grouping of pilot symbols composed of identical sequence units that may be called ‘Unique Words’ (UWs). These UWs may be chosen to have good autocorrelation properties, such as those described in the trio of three references identified above. Each of the UWs is of length U symbols, and, for best effect, is preferably at least as long as the delay spread that is observed on the operating channel. Furthermore, as compared to ‘dual-blocks’ for payload data (see FIGS. 1 and 2), UWs are likely to be shotrter, repeated in groups, and averaged before processing.

As shown in FIG. 5, an identical UW block 502 is repeated J times using the format shown for the block 306 in FIG. 3 to form a first repetition block 504 for transmit antenna 0, and is also repeated P times using format shown in block 308 of FIG. 3 to form a second repetition block 506 for the transmit antenna 0. Similarly, UWs 510 (related to the UWs 502) are repeated J times using the format of the block 310 of FIG. 3 to form a repetition block 504 for transmit antenna 2, and UWs 512 (differently related to the UWs 502) are repeated P times using the format of the block 312 of FIG. 3 to form a second repetition block 506 for the transmit antenna 2. This grouping reduces overhead, since the first UW in each repeated block also serves as a cyclic prefix guard interval to guard the signals that follow from the corrupting delay spread of previously transmitted signals. Because it serves as a guard interval, the first UW in a repetition block might be corrupted and thus not useful for channel estimation purposes. However, the successive (J−1) or (P−1) blocks are typically usable. J and P will commonly be identical values.

To perform channel estimation, each of the useable UWs within a repetition block 504 may be paired with a corresponding UW within the corresponding repetition block 506. The receiver signal processing may then estimate the channels in the frequency domain by performing the steps described by Eqn. 18 (following a Fourier transform, such as a fast Fourier Transform FFT or DTFT), or in the time domain by performing the steps described by Eqn. 19. If J=P, and if the first UW is used exclusively as a cyclic prefix, then (J−1) channel estimates may be made, one from each pair of UWs, and the resulting (J−1) channel estimates may then be averaged. (Up to (J−1)*(P−1) different estimates could be made and then averaged to small advantage over the (J−1) different estimates described.) A more computationally efficient (but mathematically substantially identical) approach is to average together the (J−1) blocks within the repetition block 504, average together the (P−1) uncorrupted blocks within the repetition block 506, and then apply estimation techniques such as Eqn. 18 or Eqn. 19 on these averaged results. This technique is convenient even when J≠P.

Burst transmissions often require channel estimation before processing of the payload data can commence. FIG. 6 illustrates a burst communication timing structure 600 that uses a burst preamble 602 to assist in initial channel estimation. Referring also to FIG. 5, the preamble 602 is one location where the pilot symbol structure of FIG. 5 may be applied, using repetition blocks 504 and 506 of UWs (which may take the form of UWs 502, 510 or 512). Payload data 604 may itself consist of one or more dual blocks (e.g., 100 in FIG. 1). A ramp-up region 606, where the transmitter ramps up its output power, may also be constructed as a (partial) cyclic prefix, in which event it could include several of the last symbols within a first UW 610 in the burst preamble 602. Use of such a ramp-up 606 can reduce timing accuracy requirements for the reception of a burst, and enable more efficient utilization of the symbols within the preamble 602. A ramp-down region 612 typically also exists, and may reduce spurious emissions that would otherwise result from a sharp step in transmit power.

Most communication channels change with time. If a burst is short enough, and the channel change is slow enough, no update of a channel estimate may be necessary. However, for continuous communication channels, or longer bursts, updated channel estimates are generally necessary. Such estimates may be derived from the arbitrary payload data (e.g., 604). The transmitter may also insert a known sequence, referred to as a pilot word, from which the channel can be estimated.

FIG. 7 illustrates the insertion of pilot words 702 within a representative payload 704. In one structure, pilot words are arranged in a form as illustrated in FIG. 5, with a repetition block 504 of UWs followed by a repetition block 506 of UWs. Pilot words may be inserted after one or more block pairs, for example after multiple block pairs 706 or 708, and may have a periodic spacing interval if multiple block pairs 706 and 708 have the same length. Pilot words may have a basic format similar to a preamble, although the number of sub-blocks (e.g., UWs) in a preamble repetition block is likely to differ from the number of sub-blocks in a pilot word repetition block.

Dual Block Structure Refinements

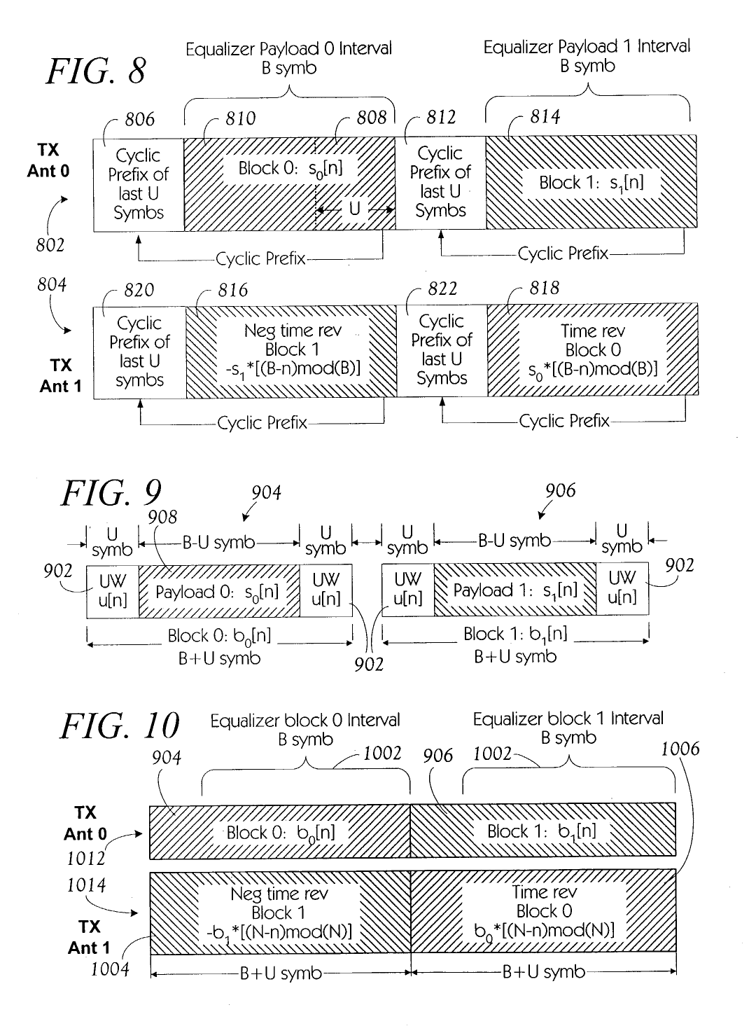

FIG. 8 illustrates use of cyclic prefixes by transmitter processing facilities with block pair structures 802 (for the first transmit antenna) and 804 (for the second transmit antenna). Aside from the explicit cyclic prefixes, the block pairs 802 and 804 are similar to the general block pair 100 of FIG. 1 with the multiplexing features shown in FIG. 3. As can be seen, a cyclic prefix 806 is composed of the last U symbols 808 that typically form part of a “Block 0” 810. Similarly, a cyclic prefix 814 is formed of the last U symbols (not separately identified) of a “Block 1” 814. The blocks 810, 814, 816 and 818 are shown to have the multiplexing structure of the respective blocks 306, 308, 310 and 312 of FIG. 3. The cyclic prefixes 806, 812, 820 and 822 each perform the function of the general delay spread guard interval 106 illustrated in FIG. 1.

FIG. 9 illustrates a specific case of dual block structure in which a Unique Word (UW) 902 is used to implement the cyclic prefix used as a guard interval for blocks 904 and 906. As in FIG. 8, the block 904 includes (B+U) symbols. However, since the U symbols of the UW 902 generally do not carry new information (such as data to be conveyed across the wireless link), and since the last U symbols of the payload of the block 904 are identical to the UW 902, the effective payload 908 of the block 904 is (B−U) symbols.

FIG. 10 illustrates the portions 1002 of blocks 904, 906, 1004 and 1006 that the receiver signal processing may be restricted to considering for most sequence calculations, since the portions 1002 follow the UW cyclic prefix that functions as a delay spread guard interval. One or more UWs may thus incorporated into the equalizer portions 1002. While not generally constituting new data, these UWs may be used to initialize the memory of the feedback filter used in a Decision Feedback Equalizer as described with respect to FIG. 4. FIG. 10 also illustrates the UW cyclic prefix structure of FIG. 9, in the context of a block pair 1012 for transmit antenna 0 and a block pair 1014 for transmit antenna 1, that follows the general dual block pair multiplexing structure illustrated in FIG. 3. The generality of the symbol sequences of such dual block pairs should be borne in mind, since if {b₀[n]}32 {c₀*[(N−n) mod(N)]} and the latter is substituted for the former, then an apparently different signal multiplexing format is described by the block pair structure of FIG. 10. However, such difference is apparent only, and involves only a substitution of form that is encompassed by the generality of block symbol sequences.

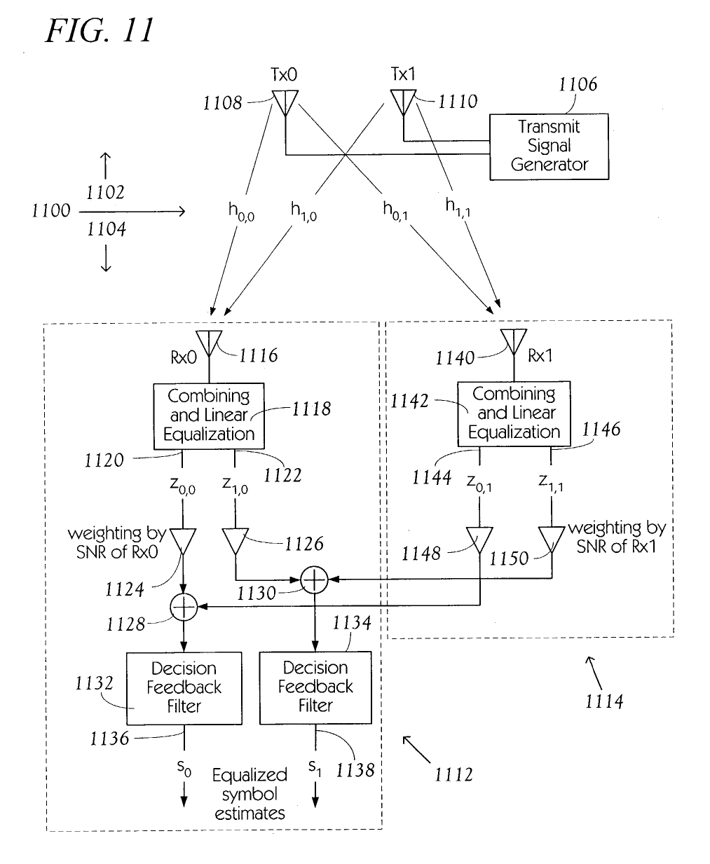

FIG. 11 illustrates a wireless link system including a link medium 1100, a transmission system 1102 (shown as above the medium 1100), and a receiver system 1104 (shown as below the medium 1100). The transmission system 1102 includes a transmit signal generator block 1106 that may be configured to prepare at least two signals using any combination of the block pair transmission techniques discussed above. The transmit signal generator block 1106 delivers multiplexed signals (e.g., a first block pair) to a first transmit antenna Tx0 1108, and related multiplexed signals (e.g., a second block pair) to a second transmit antenna Tx1 1110. The receiver system 1104 is shown with two cooperating receivers 1112 and 1114.

The first receiver system 1112 may be viewed as a stand-alone receiver, operating according to the teaching above, by ignoring the second receiver 1114 for a moment. The first receiver system 1112 includes a first receive antenna Rx0 1116, which provides the signals received from Tx0 1108 and Tx1 1110 via two wireless channels, which are represented as h_{0,0} and h_{1,0}. A combining and linear equalization block 1118 may, in general, process the received block pairs in any combination of time domain and/or frequency domain, as described above, to provide outputs 1120 and 1122. If the outputs 1120 and 1122 are in the time domain (either because they were processed in the time domain, or by inverse Fourier transform from a frequency domain representation), they may be interpreted directly as the receiver's estimates of the transmitted sequences S₀ and S₁, essentially bypassing further processing and becoming estimate outputs (this technique is not shown).

However, the outputs may be frequency domain representations z_{0,0} and z_{1,0}, as shown. In this event, blocks 1124 and 1126 may weight the respective outputs by the SNR measured for Rx0 to effect maximal ratio combining. Since the second receiver 1114 is being ignored, the SNR weighted resultants gain nothing from the summing blocks 1128 and 1130, and go to blocks 1132 and 1134, respectively. If the resultants are already in the time domain, the sums may be interpreted directly as transmitted symbol sequence estimates, or may be passed on directly for decision feedback filtering. If the resultants are in the frequency domain, then blocks 1132 and 1134 may simply transform by inverse Fourier to the time domain and interpret the results as transmitted sequence estimates.

The blocks 1132 and 1134 may also perform decision feedback filtering as described above to produce outputs 1136 and 1138 as decision feedback equalized estimates of the transmitted sequences {ŝ₀[n]} and {ŝ₁[n]} (indicated as s₀ and s₁), respectively. Each of the blocks shown within the first receiver 1112 thus represents a possible system block for a receiver using some combination of the time and/or frequency domain combining and equalization techniques described herein.

FIG. 11 also illustrates an extension of the techniques described herein for using a plurality of cooperating receivers. The second receiver 1114 is now taken into consideration, beginning with a second antenna 1140, which receives the multiplexed signals from Tx0 1108 and Tx1 1110 via two corresponding channels represented as h_{0,1} and h_{1,1}. The two receivers each perform transmit diversity combining and linear (feedforward) equalization independently, as shown, in their respective combining and linear equalization blocks 1118 and 1142.

For cooperating receivers, the combining and linear equalization block 1142 will generally be configured identically to the block 1118. The signals may be transformed to the frequency domain within the combining and linear equalization processes, as described above and preferably by the same processing used in the combining block 1118, to provide frequency domain outputs 1144 and 1146, indicated as z_{0,1} and z_{1,1}. Weighting by the SNR determined for Rx1 to effect maximal ratio combining may be performed in the blocks 1148 and 1150.

At this point in cooperating receiver processing, the weighted resultants from the second receiver 1114 are added, at the summing blocks 1128 and 1130, respectively, to the weighted resultants developed within the first receiver 1112. The sums from these blocks may then be converted to the time domain by inverse Fourier transformation. As shown, decision feedback filtering may be performed on the summed resultants in the blocks 1132 and 1134, respectively, and the outputs 1136 and 1138 may be interpreted as estimates of the transmitted sequences {ŝ₀[n]} and {ŝ₁[n]} (indicated as s₀ and s₁), respectively. The channel equalization is expected to correct for carrier phase and timing offsets, so that the SNR-weightilg procedure does not require phase-alignment of the two inputs that feed the summing blocks 1128 and 1130. If the equalization does not completely compensate for carrier phase offsets, phase alignment may be necessary.

Additional receivers may also be used, performing the functions shown for the second receiver 1114, and similarly summing their combined and weighted outputs into the summing blocks 1128 and 1130, for (typically) further processing through decision feedback filters to produce estimates of the transmitted sequences.

When pilot symbols are used, typically each receiver independently performs channel estimation. When arbitrary data is used as a reference for channel estimation, each receiver may still independently perform channel estimation, but the sequence estimates at the output of the decision feedback filters may need to be fed back to the corresponding receiver to improve the reliability of the symbol estimates used by the channel estimation procedure.

Single Carrier Diverse Antenna Processing for Delay-Spread Channels

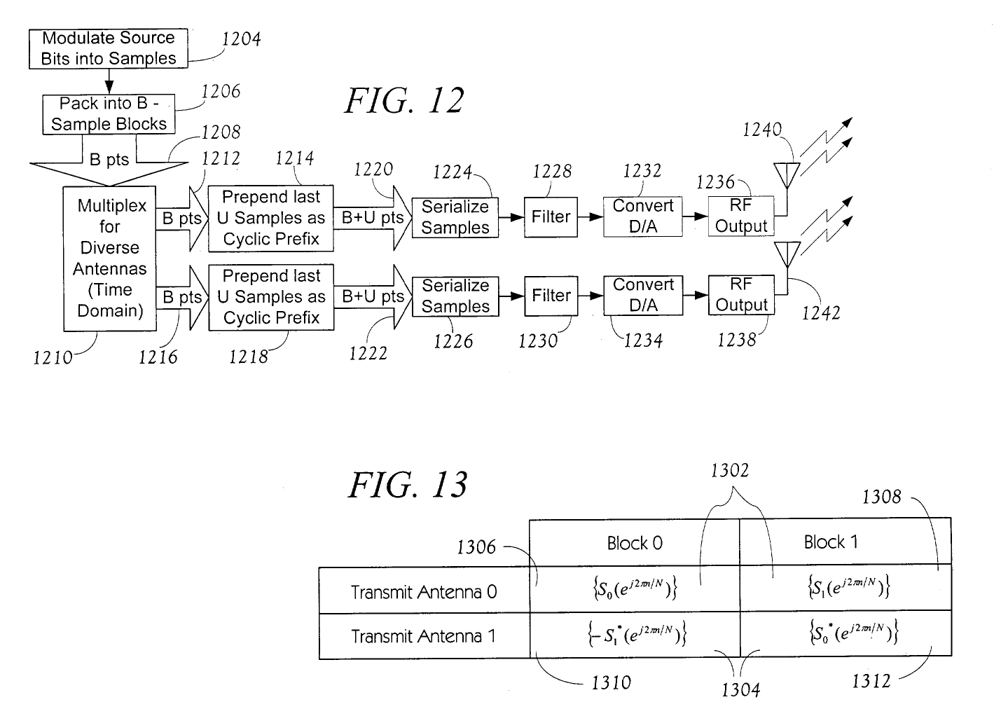

FIG. 12 is a block diagram of processing blocks for some embodiments of single carrier diverse antenna transmission processing. Source bits, indicated at a block 1204, may be modulated into a sequence of samples at a processing block 1204. Note the slight change in terminology from “symbols” to “samples,” which will facilitate comparison between FIG. 12 and subsequent figures. Modulation may be performed by any appropriate technique, such as Quadrature Amplitude Modulation (QAM), in which case the samples of the resulting sequence will each have two orthogonal components (a real component and an imaginary component). A processing block 1206 represents selecting or identifying blocks of an appropriate length (B samples, for consistency). These B-point blocks are conveyed (as indicated by a processing arrow 1208) to a processing block 1210, where they are multiplexed for transmission from diverse antennas according to time domain techniques as described hereinabove in great detail. The block 1210 multiplexing results in “dual block pairs” as described with respect to FIG. 3. Referencing FIG. 3 as well as FIG. 12, B-point blocks 306 and 308 constitute a first block pair 302, while B-point blocks 310 and 312 constitute a second block pair 304. The B-point blocks 306 and 308 are conveyed as indicated by processing arrow 1212 to a processing block 1214, where the last U samples of each block are copied and prepended to the block as a cyclic prefix. Cyclic prefixes are similarly prepended to the B-point blocks 310 and 312, after they are conveyed as shown by processing arrow 1216, in a processing block 1218. Prepending the last U samples of each B-point block establishes (B+U)-point blocks, which are conveyed for further processing as indicated by processing arrows 1220 or 1222. Such further processing may include serializing the samples at a block 1224 or 1226, digitally filtering the samples at a block 1228 or 1230, converting the samples from digital to analog at block 1232 or 1234, amplifying the resulting radio frequency signal at block 1236 or 1238. This processing is exemplary, and any appropriate process may be used for converting the (B+U)-sample block pairs into signals for transmission. However processed, the resulting signals will be radiated by a first antenna 1240, or by a second antenna 1242, respectively.

### Transmit Diversity Applied to OFDM for Delay Spread Channels

Orthogonal Frequency Division Multiplexing (OFDM) communications can benefit from techniques described herein, and many of the signal relationship equations that are specified above are applicable to OFDM communication signals. FIG. 13 illustrates relationships that may be used with OFDM processing to multiplex a single stream of information into dual streams of OFDM symbol pairs for transmission by dual antennas.

Terminology differences between OFDM and single-carrier signals warrant consideration. The term “OFDM symbol” is generally used herein for distinction from single carrier “blocks.” However, both OFDM symbols and single carrier blocks are examples of “signal units.” Signal units may have an associated length of an integer number of “points.” Thus, for example, an N-point OFDM symbol on the one hand, and a block of N samples of a single carrier signal on the other hand, may both be referred to as N-point signal units.

OFDM Block Pair Multiplexing

FIG. 13 shows a first pair of OFDM symbols 1302 associated with a first antenna (Transmit Antenna 0), and a second OFDM symbol pair 1304 associated with a second antenna (Transmit Antenna 1). In accordance with standard OFDM processing, each OFDM symbol is derived from N sample points, and thus will be referred to as an N-point OFDM symbol. The first OFDM symbol pair 1302 includes a first N-sample OFDM symbol 1306 having the form S₀(e^{j2πn/N}), n={0,1, . . . , N−1} and a second N-sample OFDM symbol 1308 having the form S₁(e^{j2πn/N}), n={0,1, . . . N−1}. The second OFDM symbol pair 1304 includes a third N-sample OFDM symbol 1310 and a fourth N-sample OFDM symbol 1312. The third OFDM symbol 1310 has the form −S₁*(e^{j2πn/N}), n={0,1, . . . , N−1}, and is thus related to the second OFDM symbol 1308 as its negative complex conjugate. The fourth OFDM symbol 1312 is related as the positive complex conjugate of the first OFDM symbol 1306, and accordingly takes the general form S₀*(e^{j2πn/N}), n={0,1, . . . , N−1}.

OFDM Transmit Diversity Processing

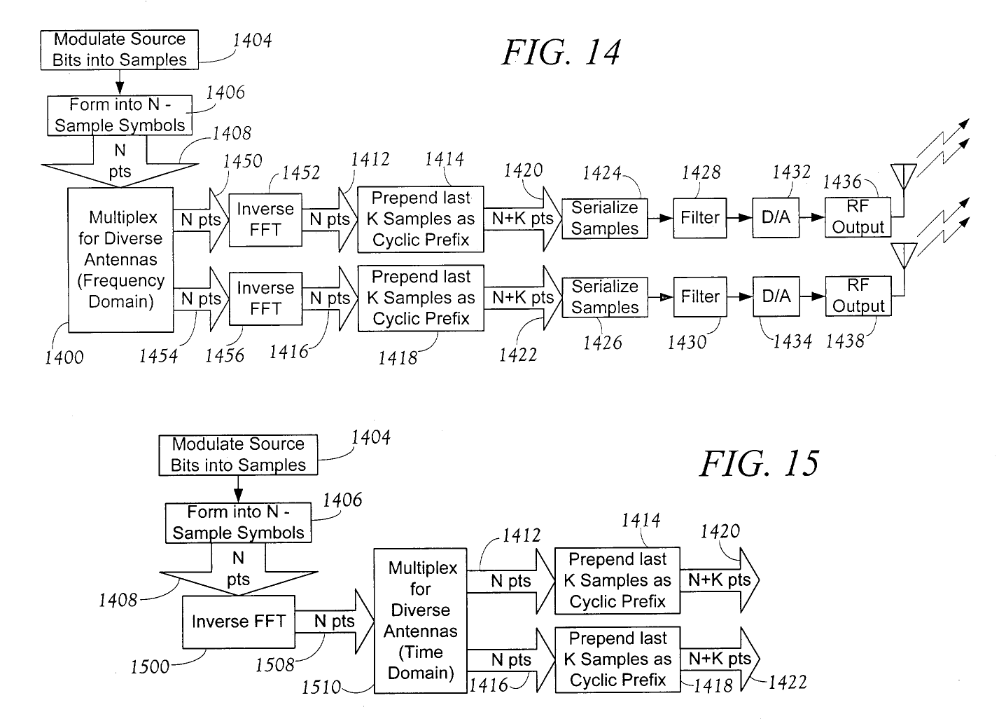

Cyclic prefixes may improve reception accuracy for OFDM symbols, particularly in delay-spread channels. FIG. 14 illustrates OFDM transmit diversity processing that includes prepending cyclic prefixes to transmission blocks in a manner that is analogous in many regards to the single-carrier processing illustrated in FIG. 12. An important distinction, however, is the frequency domain processing of a block 1400 by which pairs of incoming N-sample OFDM symbols are multiplexed into dual N-sample OFDM symbol pairs in accordance with the forms shown in FIG. 13.

In FIG. 14, a first block 1404 represents appropriate steps to modulate incoming source bits into samples. Any modulation technique may be used for this step that is compatible with the other processing, with QAM being typical. At a block 1406, sets of N resulting samples are formed into N-sample OFDM symbols. The N point symbols are conveyed, as indicated by the arrow 1408, to the processing block 1400 for multiplexing as described above, such that pairs of N-sample OFDM symbols are multiplexed into dual OFDM symbol pairs related as shown in FIG. 13.

A processing arrow 1450 indicates that N-point OFDM symbols (for example, sets of N-sample OFDM symbols 1306 and 1308 in FIG. 13) are conveyed to a block 1452, where an inverse FFT is perfonied to generate blocks of N time domain samples. Similarly, a processing arrow 1454 represents conveying N-point OFDM symbols (for example, sets of N-sample OFDM symbols 1310 and 1312 in FIG. 13) to a block 1456 for inverse FFT processing to generate N-sample blocks in the time domain. From this point forward, the steps may be very similar to those shown in FIG. 12, and thus the reference numbers are similar. As indicated by an arrow 1412 (or 1416), the N-point time domain samples may be conveyed to a block 1414 (or 1418) where the last K samples of the block are prepended to form a cyclic prefix. This creates blocks of (N+K) samples, which are conveyed as indicate by an arrow 1420 (or 1426) to a filter 1428 (or 1430), a digital to analog converter 1432 (or 1434), and an RF output state 1436 (or 1438).

Improved Processing for OFDM Dual Symbol Pair Transmission

The result achieved by processing according to FIG. 14 may also be achieved as shown in FIG. 15. In particular, an inverse FFT may be performed at a processing block 1500 on N-point OFDM symbols that are received, as indicated by arrow 1408, after modulation of source bits in block 1404 and packing into N-sample OFDM symbols in block 1406, in the same manner as indicated in FIG. 14. However, the processing block 1500 may perform an inverse FFT on each of the received N-point OFDM symbols, yielding N-point blocks of time domain samples that are passed on for further processing as indicated by an arrow 1508. Multiplexing of the N-sample blocks for transmission from diverse antennas may then be done in the time domain in a processing block 1510.

Such time domain multiplexing is described above in detail, and may yield dual pairs of blocks of symbols that are related as shown and described with respect to FIG. 3, or in an equivalent form. As described more fully above, such time domain multiplexing creates N-point blocks that are related not only by complex conjugation (with or without real inversion), but also by time reversal of the samples of the block, modulo N. Once these time-domain dual block pairs are generated in the processing block 1510, they may be transferred (arrow 1412 or 1416) for addition of the cyclic prefix (processing block 1414 or 1418), and the resulting (N+K)-sample blocks may be conveyed (arrow 1420 or 1422) for further processing in the same manner as shown in FIG. 14.

Only half as many inverse FFTs need be performed according to the processing shown in FIG. 15, as compared with the processing shown in FIG. 14, if other factors are the same (such as data rate, modulation technique, number of points in OFDM symbols, and so on). That is because block 1500 performs inverse FFTs on only the “original” N-point OFDM symbols received as shown by arrow 1408, whereas in FIG. 14 inverse FFTs are performed (at blocks 1452 and 1456) on the different forms (1450, 1454) that are derived from each of the “original” OFDM symbols (from 1408) by multiplexing in the block 1400. The difficulty of multiplexing time-domain N-point blocks into dual block pairs (block 1510) may be comparable to the difficulty of multiplexing frequency-domain N-sample OFDM symbols into dual OFDM symbol pairs (block 1400), and, therefore, processing in accordance with FIG. 15 may require significantly less effort than processing in accordance with FIG. 14, other conditions being equal.

OFDM Transmit Diversity Receiver Processing

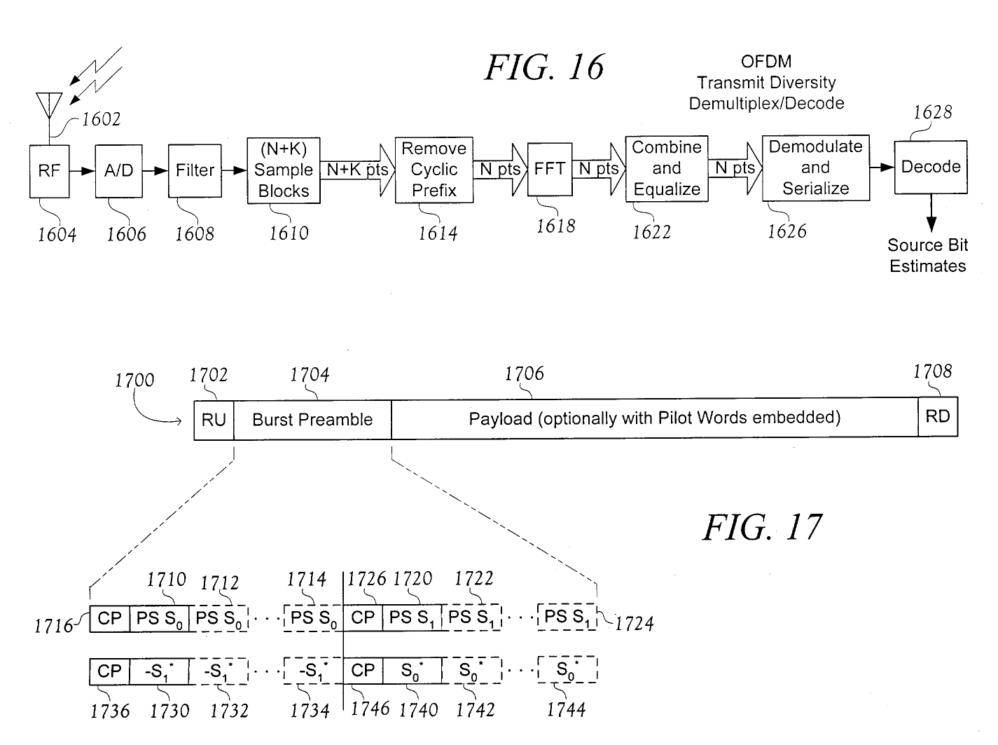

FIG. 16 illustrates exemplary receive processing for OFDM diverse antenna transmissions. Signals received at an antenna 1602 may be amplified with a RF amplifier as shown at block 1604 before the signal is digitized in an A/D converter at block 1606. Digital filtering may then be performed in a block 1608 (filtering may also be performed elsewhere) before (N+K)-sample blocks, including cyclic prefixes, are identified at a block 1610. The cyclic prefix may be removed from the N+K samples at a block 1614 to yield N-sample blocks. The N-sample blocks may be converted to a frequency-domain representation by means of a FFT at a block 1618 to yield N-point OFDM symbols.

The received N-point OFDM symbols should be identified as pairs R₀, R₁ (typically by expected position with respect to a preamble or pilot word), and then combined and equalized in a block 1622 to extract an estimate of the transmitted OFDM symbols. Combining may be done in any appropriate manner, such as in accordance with Eqn. 2 above, to yield C₀ and C₁. These intermediate results may be equalized, for example in accordance with Eqn. 7 (linear equalization), with E determined by ZF optimization (Eqn. 8) or MMSE (Eqn. 9). A resulting estimate of the transmitted OFDM symbols may then be demodulated, typically into blocks of parallel data that may need to be re-serialized in a block 1626. The OFDM symbol estimate may then be decoded in a block 1628 to yield a reconstruction of the original source bits that informed the OFDM transmission.

Channel Estimation with OFDM

Combining and equalization for received pairs of N-point OFDM symbols depends upon estimating channel responses for the two channels. For channel estimation purposes, it is often useful to transmit OFDM symbols that are expected by the receiver, thus eliminating uncertainty due to estimation of the signal. Such expected symbols may be called “pilot symbols” (“PSs”) in regard to OFDM, which is an example of a “pilot signal unit.” The known symbols may be sent, for example, as part of pilot words that are interspersed within payload transmissions in the manner shown in FIG. 7, or as part of a burst preamble, in the general manner shown in FIG. 6. Given known symbols S₀, S₁ (and the related symbols derived therefrom), channel estimates may be determined using MMSE techniques in accordance with Eqn. 16, or by zero forcing techniques as indicated in Eqn. 17. Channel estimates may be developed using special pilot words, as described below

Preambles and Pilot Words with OFDM

FIG. 17 illustrates a burst frame structure 1700 for an OFDM communication. Transmitted OFDM symbols are simply represented as Sₓ. A ramp-up period 1702 may be used with any signal, related to the preamble or not, to bring the transmit power up to the desired level. The ramp-up may be omitted, or may partially overlap the burst preamble, though this could impair accuracy if the cyclic prefix is not sufficiently long compared to the range (or spread) of delays experienced by the channel. A burst preamble may be transmitted next, followed by a payload 1706. At the end of the burst, a ramp down period may be provided. The payload 1706 may optionally be interspersed with pilot words, generally in the manner shown in FIG. 7. Details of a range of embodiments for the burst preamble 1704 are shown in FIG. 17 and described below, and pilot words within a payload may also utilize the same range of structures that is described for preambles. The broken lines extending from the burst preamble 1704 identify structural details that may be included within a burst preamble (or within a pilot word).

Repetitive Pilot Symbols

Within the details of the burst preamble, a first pilot symbol (PS) 1710 is identified as an OFDM symbol S₀. The first PS 1710 may be followed by one or more additional PSs, represented as a PS 1712 to a PS 1714, for a total of J such PSs. A cyclic prefix 1716 will typically be useful, particularly in significantly delay-spread channels. It will generally constitute the last K samples of the L samples in the first PS 1710. There is no general requirement that the first PS 1710 be the same symbol as any other PS in the preamble. However, repeated symbols obviate a need for cyclic prefixes between such repeated symbols, resulting in some increase in efficiency. Accordingly, each of the PSs 1710 to 1714 are shown, in FIG. 17, as equal to S₀.

In order to utilize the dual-symbol pair antenna diversity multiplexing described above, a second set of one or more PSs 1720 to 1724 (for a total of P PSs, where typically P=J) may follow the J PSs 17 10 to 1714. These are identified as each being S₁, which may be the same or different than S₀. As before, a cyclic prefix 1726 may be used, and only one such cyclic prefix is needed for all J PS if the PSs 1720 to 1726 are identical. The structure illustrated by the first cyclic prefix 1716 to the optional last PS 1724 represents the transmission from a first antenna.

In accordance with dual symbol-pair diverse transmit antenna multiplexing techniques, a second antenna may transmit PSs (pilot symbols) that are related to those sent on the first antenna. These are represented in FIG. 17 as PSs 1730 to 1744, with vertical alignment of the various PSs indicating temporal transmission time alignment. Thus, PSs 1730 and optional additional PSs 1732 and 1734 (generally a total of J PSs) will be transmitted from the second antenna approximately concurrently with the J PSs 1710 to 1714 that are transmitted from the first antenna. There may be a first cyclic prefix based upon the last K samples of the PS 1730. PSs 1730 to 1734 are shown as being identical to each other, and more cyclic prefixes may be needed if this is not the case. A further set of P PSs may follow the PSs 1730 to 1734, including a first PS 1740 and optional additional PSs 1742 to 1744. A cyclic prefix prepended to the PS 1740 may be derived from the last K samples of the PS 1740.

Varying Pilot Symbol Size and Repetition Number

PSs need not reflect the same number of samples (or points) as symbols that are used for other purposes, such as payload transmission. For example, an OFDM transmitter may typically employ 256-point symbols for payload transmission, and yet employ 64-point PSs (pilot symbols). Note that if the PS 1710 is approximately the length desired for the cyclic prefix 1716, then the cyclic prefixes (1716, 1726, 1736, 1746) may be made identical to their respective PSs 1710, 1720, 1730, 1740—S₀, S₁, −S₁* and S₀*, respectively.

Depending upon the current channel conditions and signal to noise ratio, burst preambles may utilize varying numbers J and/or P of PSs. Thus, if a somewhat better channel estimate is needed, J may be changed from 4 to 5, a 25% step, which requires a much smaller additional time (and thus effective communication bandwidth) “penalty” than would be incurred if PSs were limited to the payload length (e.g., 256), and J had to be increased from 1 to 2. Moreover, employing repetitive PSs provides up to J*P channel estimates. This product may be increased without incurring a transmission time penalty by decreasing the size of PSs.

As a further benefit, if each pilot word is shorter, pilot words may be interspersed more frequently within payloads without incurring a time penalty. More frequent pilot words may be particularly useful in conjunction with rapidly varying channels, such as may be caused by a fast-moving receiver. Additionally or alternatively, the length of pilot words within a payload may be adjusted by finer incremenits if the pilot words are composed of shorter PSs. Changes in the pilot words (and preambles), such as PS length, repetition number J and/or P, and time between pilot words, may be varied dynamically depending upon conditions of the channel. Thus, using PSs with different, typically shorter, lengths, and in repetition groups having varying numbers for J and P, may provide useful flexibility for preambles and pilot words in some systems.

Processing shorter PSs may require configuring the FFT and IFFT processors to handle such shorter symbols. The frequency domain channel response estimate representations will typically be wanted with the same number of points as the payload symbols. If the PSs have less points than payload symbols, the PS length can be extended by interpolation, using an interpolation filter such as sin(x)/x, to match the payload symbol length, and the extended “PSs” can then be processed using payload symbol-length processing. It is also possible to perform the interpolation later, after some portion of the processing has been performed with reduced-length PSs. The interpolation may even be performed after reduced frequency-sample channel estimates have been derived from reduced-point PSs.

Receive Processing of OFDM PS Pairs

At the receiver, dual PS pairs can be identified and combined together in accordance with the transmit diversity demultiplexing techniques described above. The dual PS pairs were presumably transmitted as two forms of two PS symbols, as indicated in FIG. 13. For example, the PS 1730 is related as the negative complex conjugate of the PS 1720, while the PS 1740 is related as the (positive) complex conjugate of the PS 1710. Furthermore, the PS 1710 is transmitted from the first antenna approximately concurrently as the PS 1730 from the second antenna, and PSs 1720 and 1740 are similarly concurrent. These four PSs thus form a dual PS pair for transmission, which appears at a receive antenna as a single pair of PSs. The received pairs of multiplexed (or merged) PSs will be referred to as RP₀ (from merged concurrent PSs 1710 and 1730) and RP₁ (from merged concurrent PSs 1720 and 1742). RP₀ and RP₁ may be combined (or demultiplexed) to extract estimates of the original symbols PS₀ and PS₁, or may be used for channel estimation.

Noise effects on any estimation processes may be reduced by averaging in several ways. Because all significant noise is additive, the simple expedient of averaging together each set of J (or P) PSs, then processing the resulting averages as a dual PS pair, will reduce noise effects on channel estimates approximately equivalently to more complex techniques that may be employed. Assuming that the transmission was as shown in FIG. 17, the receiver may receive J versions of RP₀, and P versions of RP₁. The J versions of RP₀ may be averaged together to form A_{J}RP₀, the P versions of RP₁ may be averaged together to form A_{P}RP₁. Two such resultant averages (generally, A_{N}RP_{X}) may be used to estimate the channel responses H₀ and H₁, according to Equations 16 or 17, by substituting A_{N}RP_{X} for R_{X}, and the known values PS_{X} for S_{X}.

Alternatively, any of the J versions of RP₀ may be substituted for R₀, and any of the P versions of RP₁ may be substituted for R₁ in Equations 16 or 17 (along with PS_{X} for S_{X}) to obtain up to J*P different estimates for H₀ and H₁. In order to realize most of the noise averaging effects by this technique, each of the J versions of RP₀, and each of the P versions of RP₁, should be used in at least one estimate of H₀ and H₁. The different estimates of H₀ and H₁ thus derived may then be averaged together. Thus, for example, if P=J=2, a first pair of estimates H₀ and H₁ may be derived from combination of the first RP₀ with the first RP₁, a second pair of estimates H₀ and H₁ may be derived from combination of the second RP₀ with the second RP₁, and these two pair of estimates may be averaged to form an improved estimate of H₀ and H₁. Up to P*J different estimates of channel may be derived, but for most practical systems the extra estimates add little information to improve the ultimate averaged channel estimates.

Referring again to FIG. 17, the first transmitted PS pair (1710 and 1730) may be temporally separated from the second transmitted PS pair (1730 and 1740). As long as the PSs are repetitive, as shown in FIG. 17, further dual PS pairs may be identified as: the pair 1710/1730 with the pair 1722/1742, or with the pair 1724/1744; and the pair 1712/1732 with the pair 1720/1740, or with the pair 1722/1742, or with the pair 1724/1744, and so on. Each of the identified dual PS pair combinations may be processed to obtain a different estimate for the channel responses, H₀ and H₁. (Note the shorthand representation of simple uppercase letters for frequency domain values.) These various different estimates (up to J*P, preferably at least [J+P]/2 using each RP₀ and each RP₁ once) may then be averaged together to obtain an improved estimate.

The embodiments of transmitter symbol multiplexing and receiver equalization and symbol recovery that are described above are intended to assist with understanding of the invention that is claimed in each claim that follows this description. The description illustrates and explains exemplary implementation of aspects of such claimed invention, but should not be construed as limiting the scope of such invention, which instead is precisely defined by the express language of a claim.

While the above description has pointed out novel features of the invention as applied to various embodiments, the skilled person will understand that various omissions, substitutions, and changes in the form and details of the methods and systems illustrated may be made without departing from the scope of the invention. For example, extra translations of symbol blocks may create alternative multiplexing forms that are, however, entirely equivalent to those described above. The skilled person will be able to adapt the details described herein to communications systems having a wide range of modulation techniques, transmitter and receiver architectures, and generally any number of different formats. In particular, each functional combination of multiplexing, combining, equalization and framing techniques and/or system elements described herein, with other wireless communication techniques and/or system elements that are presently known or later developed, is contemplated as an alternative or equivalent embodiment of an aspect of the invention.

The various techniques set forth above may be performed within, or by, any appropriate signal processing facilities. Different facilities may divide tasks up in different ways than those illustrated. For example, transmitter signal processing may be performed in any number of processing modules or subsections, whether or not they track the logical structure illustrated, as long as the same or equivalent functions are ultimately performed somewhere. Receiver signal processing may similarly be performed in different orders and combinations, providing that equivalent functions are performed somewhere. Any appropriate techniques for multiplexing at the transmitter, and for combining (demultiplexing) at the receiver, may be used in conjunction with the framing, preamble and pilot word forms described above.

Each practical and novel combination of the elements described hereinabove, and each practical combination of equivalents to such elements, is contemplated as an embodiment of the invention. Because many more element combinations are contemplated as embodiments of the invention than can reasonably be explicitly enumerated herein, the scope of the invention is properly defined by the appended claims rather than by the foregoing description. All variations coming within the meaning and range of equivalency of the various claim elements are embraced within the scope of the corresponding claim. Specific combinations of elements are set forth as claims, appended below, to define the invention in various aspects. It should be understood that due to the imperfection of humans and language, a particular claim may not perfectly define such invention. For example, no claim is intended to encompass the prior art, and each claim should be reasonably interpreted, if possible, to avoid such unintended coverage. Conversely, each claim is intended to encompass any system or method that differs only insubstantially from the literal language of such claim, so long as such system or method is not, in fact, an embodiment of the prior art. To this end, each described element in each claim should be construed as broadly as possible, and moreover should be understood to encompass any equivalent to such element insofar as possible without also encompassing the prior art.

What is claimed is:

1. A method of transmitting dual signal-unit pairs from diverse antennas, comprising
a) deriving a first N-point signal unit from a first portion of source data, and deriving a second N-point signal unit from a second portion of source data,
b) processing in the time domain to
i) establish a complex conjugated and modulo-N time-inverted form of the first N-point signal unit as a first variant signal unit,
ii) establish a negative complex conjugated and modulo-N time-inverted form of the second N-point signal unit as a second variant signal unit, and
iii) prepend a corresponding cyclic prefix on each signal unit to form a prefixed first signal unit, a prefixed first variant signal unit, a prefixed second signal unit, and a prefixed second variant signal unit;
c) transmitting, substantially concurrently, the prefixed first signal unit from a first antenna and the prefixed second variant signal unit from a second antenna, and
d) transmitting, substantially concurrently, the prefixed second signal unit from the first antenna and the prefixed first variant signal unit from the second antenna.

2. The method of claim 1, wherein each N-point signal unit is an N-point OFDM symbol.

3. The method of claim 1, wherein each N-point signal unit is a block of N time-domain samples.

4. The method of claim 3, wherein the time domain samples are samples from a single carrier modulation system.

5. The method of claim 1, further comprising:
e) transmitting a pilot word from the diverse antennas by
i) establishing an M-point first pilot signal unit expected by a receiver and an M-point first variant pilot signal unit that is a form of the first pilot signal modified by complex conjugation,
ii) establishing an M-point second pilot signal unit expected by the receiver and an M-point second variant pilot signal unit that is a form of the second pilot signal modified by both complex and real conjugation,
iii) cyclically prefixing each pilot signal unit to form a prefixed first pilot signal unit, a prefixed first variant pilot signal unit, a prefixed second pilot signal unit, and a prefixed second variant pilot signal unit,
iv) substantially concurrently transmitting the prefixed first pilot signal unit and the prefixed second variant pilot signal unit from the diverse antennas, and
v) substantially concurrently transmitting the prefixed second pilot signal unit and the prefixed first variant pilot signal unit from the diverse antennas.

6. The method of claim 5, wherein J is an integer greater than one and/or P is an integer greater than one and step (e) further comprises:
vi) transmitting from the diverse antennas, immediately subsequent to step (e)(iv), (J−1) repetitions of the first pilot signal unit and (J−1) repetitions of the second variant pilot signal unit, and
vii) transmitting from the diverse antennas, immediately subsequent to step (e)(v), (P−1) repetitions of the second pilot signal unit and (P−1) repetitions of the first variant pilot signal unit.

7. The method of claim 6, wherein J=P.

8. The method of claim 6, wherein each cyclic prefix is identical to the pilot signal unit that it prefixes.

9. The method of claim 5, further comprising:
f) transmitting payload elements by performing steps (a), (b), (c) and (d) wherein:
i) the first and second signal units are payload signal units unknown to a receiver,
ii) L is a payload signal unit size, N=L, and
iii) L=M.

10. The method of claim 6, further comprising:
f) transmitting payload elements by performing steps (a), (b), (c) and (d) wherein:
i) the first and second signal units are payload signal units unknown to a receiver,
ii) L is a payload signal unit size, N=L, and
iii) L is not equal to M.

11. The method of claim 5, further comprising:
f) transmitting data in a frame structure that includes a burst preamble followed by a payload;
g) incorporating, within the burst preamble, the pilot word transmission of step (e) modified in that M_{PRE} is a preamble pilot signal unit size, and M=M_{PRE}; and
h) transmitting payload elements within the payload by performing steps (a), (b), (c) and (d) wherein:
i) the first and second signal units are payload signal units containing data that may be unknown to a receiver before decoding, and
ii) L is a payload signal unit size, and N=L.

12. The method of claim 11, further comprising:
j) transmitting a further pilot word within the payload as a payload pilot word by performing step (e) modified in that M_{PAY} is a payload pilot signal unit size, and M=M_{PAY}.

13. The method of claim 12, further comprising:
k) transmitting a pilot word having a repetitive pilot signal unit, by
i) including, as part of the preamble pilot word transmission of step (g), the steps of claim 5 modified in that J=J_{PRE} and P=P_{PRE}, or
ii) including, as part of the payload pilot word transmission of step (j), the steps of claim 5 modified in that J=J_{PAY} and P=P_{PAY}.

14. The method of claim 13, wherein J_{PRE}≠J_{PAY} and/or P_{PRE}≠P_{PAY}.

15. The method of claim 13, further comprising varying, in response to changes in an indication of channel condition, the value of one or more of the group consisting of J_{PRE}, J_{PAY}, P_{PRE} and P_{PAY}.

16. The method of claim 5, further comprising varying a time frequency at which step (e) is performed in response to changes in an indication of channel condition.

17. The method of claim 5, further comprising varying a value of M in accordance with changes in an indication of channel condition.

18. The method of claim 6, further comprising varying a value of J and/or a value of P in accordance with changes in an indication of channel condition.

19. A method of interpreting signals received by a receiver that were transmitted in multiplexed forms from diverse transmit antennas, the method comprising:
a) identifying a received pilot word that includes a first M-point pilot signal unit preceded by a cyclic prefix corresponding thereto, and a second M-point pilot signal unit preceded by a cyclic prefix corresponding thereto;
b) determining
i) a first pilot received signal unit PR₀ by using the first M-point pilot signal unit, after discarding the corresponding cyclic prefix, and
ii) a second pilot received signal unit PR₁ by using the second M-point pilot signal unit, after discarding the corresponding cyclic prefix;
c) producing
i) a first channel estimate H˜₀ of a first channel response H₀ by combining forms of PR₀ and PR₁ in a first manner with forms of corresponding expected pilot signal units ES₀ and ES₁, and
ii) a second channel estimate H˜₁ of a second channel response H₁ by combining forms of PR₀ and PR₁ in a different second manner with forms of ES₀ and ES₁;
d) receiving a payload element that includes a first L-point received payload signal unit R₀ and a second received payload signal unit R₁;
e) combining forms of H˜₀ and H˜₁ with forms of R₀ and R₁ to obtain a first L-point combined signal unit C₀ and a second L-point combined signal unit C₁; and
f) deriving, from C₀ and C₁, estimates S˜₀ and S˜₁ of L-point transmitted payload signal units S₀ and S₁.

20. The method of claim 19, wherein J and/or P are greater than one, and step (a) further comprises:
i) receiving J substantially similar sequential M-point pilot signal units beginning with the first M-point pilot signal unit, and
ii) receiving P substantially similar sequential M-point pilot signal units beginning with the second M-point pilot signal unit.

21. The method of claim 20, wherein step (b)(i) further comprises averaging valid ones of the J substantially similar sequential M-point pilot signal units to establish the first pilot received signal unit PR₀, and step (b)(ii) further comprises averaging valid ones of the P substantially similar sequential M-point pilot signal units to establish the second pilot received signal unit PR₁.

22. The method of claim 21, wherein M=L.

23. The method of claim 19, wherein M<L, and step (c) further comprises interpolating M-point information with an interpolation filter to establish L-point channel estimate information for L-point channel estimates H˜₀ and H˜₁.

24. The method of claim 19, wherein the received payload signal units R₀ and R₁ are L-point OFDM symbols.

25. The method of claim 19, wherein the received payload signal units R₀ and R₁ are L-sample blocks of single-carrier signals.

26. The method of claim 19, wherein step (f) further comprises multiplying C0 and C1 by an equalization function derived using Zero Forcing or Minimum Mean Squared Error optimization criteria.

27. The method of claim 19, further comprising
g) identifying a frame for a received signal burst including a burst preamble portion and a payload portion;
h) deriving preamble channel estimates by performing, for a signal within the burst preamble portion, steps (a), (b) and (c) wherein M=M_{PRE}, PR₀=P_{PRE}R₀, PR₁=P_{PRE}R₁, ES₀=E_{PRE}S₀, and ES₁=E_{PRE}S₁;
i) estimating a multiplicity of payload signal units by performing steps (d), (e) and (D repetitively for first payload signals within the payload portion;
j) deriving payload channel estimates by performing, for a signal within the payload portion and subsequent to the first payload signals, steps (a), (b) and (c) wherein M=M_{PAY}, PR₀=P_{PAY}R₀, PR₁=P_{PAY}R₁, ES₀=E_{PAY}S₀, and ES₁=E_{PAY}S₁.

28. The method of claim 27, wherein M_{PAY}≠M_{PRE}.

29. The method of claim 27, wherein J_{PRE} and/or P_{PRE} are greater than one, and step (h) further comprises:
i) receiving J_{PRE} substantially similar sequential M_{PRE}-point pilot signal units beginning with the first M_{PRE}-point pilot signal unit, and
ii) receiving P_{PRE} substantially similar sequential M_{PRE}-point pilot signal units beginning with the second MPRE-point pilot signal unit.

30. The method of claim 29, wherein each cyclic prefix of M_{PRE}-point pilot signal units is an M_{PRE}-point signal unit.

31. The method of claim 27, wherein J_{PAY} and/or P_{PAY} are greater than one, and step (h) further comprises:
i) receiving J_{PAY} substantially similar sequential M_{PAY}-point pilot signal units beginning with the first M_{PAY}-point pilot signal unit, and
ii) receiving P_{PAY} substantially similar sequential M_{PAY}-point pilot signal units beginning with the second M_{PAY}-point pilot signal unit.

32. The method of claim 31, wherein each cyclic prefix of M_{PAY}-point pilot signal units is an M_{PAY}-point signal unit.

33. The method of claim 31, further comprising:
k) adapting channel estimate quality in response to changing channel conditions by
i) sharing reception quality information between the receiver and the transmitter, and
ii) varying, in response to changes in the reception quality information, a value of one or more pilot word parameters from a group of parameters consisting of
(A) a frequency of payload pilot word transmissions,
(B) M_{PAY},
(C) J_{PAY},
(D) P_{PAY},
(E) M_{PRE},
(F) J_{PRE}, and
(G) P_{PRE}.

34. A method of transmitting dual signal-unit pairs from diverse antennas, comprising:
a) deriving a first M-point pilot signal unit from a first portion of pilot data expected by a receiver, and deriving a second M-point pilot signal unit from a second portion of pilot data expected by the receiver;
b) establishing a complex conjugated form of the first pilot signal unit as a first variant pilot signal unit, and a negative complex conjugated form of the second pilot signal unit as a second variant pilot signal unit;
c) prependiing a corresponding cyclic prefix on each of the pilot signal units of steps (a) and (b) to form a prefixed first pilot signal unit, a prefixed second pilot signal unit, a prefixed first variant pilot signal unit, and a prefixed second variant pilot signal unit;
d) transmitting, substantially concurrently, the prefixed first pilot signal unit from a first antenna and the prefixed second variant pilot signal unit from a second antenna;
e) transmitting, substantially concurrently, the prefixed second pilot signal unit from the first antenna and the prefixed first variant pilot signal unit from the second antenna;
f) transmitting a repetitive pilot signal unit without a preamble, where J and/or P is an integer greater than 1, by
i) transmitting, (J−1) times immediately subsequent to step (d), the first pilot signal unit from a first antenna and the second variant pilot signal unit substantially concurrently from a second antenna, and
ii) transmitting, (P−1) times immediately subsequent to step (e), the second pilot signal unit from the first antenna and the first variant pilot signal unit substantially concurrently from the second antenna.

35. The method of claim 34 wherein each M-point pilot signal unit is an M-point OFDM symbol.

36. The method of claim 34 wherein each M-point pilot signal unit is a block of M samples of a single-carrier signal.

37. A system for transmitting dual signal-unit pairs from diverse antennas, comprising
a) first and second antennas;
b) a signal-unit derivation block configured to derive N-point signal-units of time-domain samples from modulated source information;
c) a diversity multiplexer block configured to multiplex pairs of the derived N-point signal units into multiplexed dual signal-unit pairs, each multiplexed dual signal-unit pair including a first and a second N-pdint multiplexed-signal-unit (“MSU”) for the first antenna and a first and a second N-point MSU for the second antenna, wherein:
i) the first N-point MSU for the first antenna is related to the second N-point MSU for the second antenna by complex conjugation and modulo-N sample time inversion, and
ii) the second N-point MSU for the first antenna is related to the first N-point MSU for the second antenna by complex conjugation, negation, and modulo-N sample time inversion;
d) a first output processing block configured to cyclically prefix the first and second N-point MSUs for the first antenna, and to process the prefixed MSUs for sequential transmission from the first antenna; and
e) a second output processing block configured to cyclically prefix the first and second N-point MSUs for the second antenna, and to process the prefixed MSUs for sequential transmission from the second antenna substantially concurrently with the sequential transmission from the first antenna.

38. The system of claim 37, wherein the signal-unit derivation block (b) further comprises an inverse Fourier transform block configured to produce the N-point signal-units from N-point OFDM symbols derived from the modulated source information.

39. The system of claim 37, wherein the time domain samples are samples from a single carrier modulation system.

40. The system of claim 37, further comprising (f) a burst organization block configured to introduce one or more pilot words expected by a receiver into a signal stream of information not known to the receiver to form a burst stream of information, such that at least one cyclically prefixed pilot word dual MSU pair is transmitted substantially concurrently from the diverse antennas at an expected relative position within a transmission burst of multiple dual MSU pairs conveying the burst stream of information.

41. The system of claim 40, wherein J and P are positive integers, J≠1 and/or P≠1, and further comprising (g) a pilot word construction block configured to establish the pilot words such that the at least one cyclically prefixed pilot word dual MSU pair includes:
i) a first cyclically prefixed pilot word MSU for the first antenna, having a cyclic prefix prepended to J sequential copies of a first pilot subword,
ii) a second cyclically prefixed pilot word MSU for the first antenna, having a cyclic prefix prepended to P sequential copies of a second pilot subword,
iii) a first cyclically prefixed pilot word MSU for the second antenna, having a cyclic prefix prepended to J sequential copies of a subword related to the first pilot subword by complex conjugation, real value inversion, and sample time inversion, and
iv) a second cyclically prefixed pilot word MSU for the second antenna, having a cyclic prefix prepended to P sequential copies of a subword related to the second pilot subword by complex conjugation and sample time inversion.

42. The system of claim 41, wherein J=P.

43. The system of claim 41, wherein each pilot word cyclic prefix is identical to the pilot subword that it prefixes.

44. The system of claim 40, wherein payload dual MSU pairs convey information not know to the receiver prior to transmission, and a first cyclically prefixed pilot word dual MSU pair precedes, within the burst stream of information, all payload dual MSU pairs.

45. The system of claim 44, wherein a second cyclically prefixed pilot word dual MSU pair follows, within the burst stream of information, at least one payload dual MSU pair.

46. The system of claim 45, wherein the first and second cyclically prefixed pilot word dual MSU pairs are of different length.

47. The system of claim 44, wherein a pilot word dual MSU pair has a different length than a payload dual MSU pair.

48. The system of claim 40, wherein the burst organization block (f) is further configured to:
i) organize data intended for transmission into a frame structure that includes a burst preamble followed by a payload,
ii) incorporate a preamble pilot word having a length PrePW within the burst preamble,
iii) incorporate payload dual MSU pairs that are unknown to the receiver into the payload, and
iv) incorporate a payload pilot word having a length PayPW within the payload.

49. The system of claim 48, wherein PrePW≠PayPW.

50. The system of claim 48, wherein the burst organization block (f) is further configured to vary a length of pilot words disposed in similar relative positions within different frame structures, and/or to vary a number of pilot words disposed in such different frame structures, depending upon an indication of transmission quality.

51. A receiver system for receiving paired multiplexed signals transmitted from plural antennas, the system comprising:
a) a receive and alignment block configured to receive and align prefixed multiplexed-signal-units (“MSUs”) received sequentially in a frame structure having a preamble portion and a payload portion;
b) a cyclic prefix removal block configured to remove cyclic prefixes from received MSUs;
c) a pilot word identification block configured to identify, in accordance with relative position within the frame structure, J concatenated copies of a first received pilot MSU, RP₀, followed by P concatenated copies of a second received pilot MSU, RP₁, that were transmitted based upon a first expected pilot signal-unit EP₀ and a second expected pilot signal-unit EP₁; and
d) a channel estimation block configured to combine a representation of RP₀ and a representation of RP₁ with complex conjugated forms of EP₀ and EP₁ to create a first channel estimate H₁, and to combine the representations of RP₀ and RP₁ with forms of EP₀ and EP₁ that are not complex conjugated to create a second channel estimate HE₂.

52. The receiver system of claim 51, wherein the pilot word identification block is further configured to average the J concatenated copies of RP₀ to form the representation of RP₀, and to average the P concatenated copies of RP₁ to form the representation of RP₁, and wherein J≠1 and/or P≠1.

53. The receiver system of claim 51, wherein J=P≠1.

54. The receiver system of claim 51, wherein J≠P.

55. The receiver system of claim 51, wherein the J concatenated copies of RP₀ have a length different from a length of a payload MSU.

56. The receiver system of claim 51, wherein a length of RP₀ is less than a length of a payload MSU, and further comprising an interpolation block for deriving from the representation of RP₀ a signal-unit having a length equal to the length of a payload MSU.

57. The receiver system of claim 51, the pilot word identification block is further configured to identify the J concatenated copies of RP₀ and the P concatenated copies of RP₁ within the preamble portion of the frame structure, and to identify K concatenated copies of a third received pilot MSU RP₂ and L concatenated copies of a fourth received pilot MSU RP₃ within the payload portion of the frame structure.

58. The receiver system of claim 57, wherein K≠J.

59. The receiver system of claim 57, wherein each payload MSU is an N-point OFDM symbol.

60. The receiver of claim 57, wherein each payload MSU is an N-sample block of single-carrier signals.
